(19) United States
(12) Patent Application Publication
(10) Pub. No.: US 2025/0300338 A1
(43) Pub. Date: Sep. 25, 2025

(54) WAVEGUIDE

(71) Applicant: Robert Bosch GmbH, Stuttgart (DE)

(72) Inventors: Daniel Lopez Cuenca, Stuttgart (DE); Istvan Ther, Budapest (HU); Johannes Meyer, Ettlingen (DE); Julio Alberto Gonzalez Marin, Stuttgart (DE)

(21) Appl. No.: 18/860,833

(22) PCT Filed: Jul. 3, 2023
(86) PCT No.: PCT/EP2023/068181

§ 371 Date: Oct. 28, 2024

(30) Foreign Application Priority Data
Sep. 30, 2022 (DE) 10 2022 210 414.5

(51) Int. Cl. H01P 3/12; H01P 1/04

(52) U.S. Cl. CPC H01P 3/12; H01P 1/042

(57) ABSTRACT

The invention relates to a waveguide (1) consisting of two waveguide parts (11, 12). Each waveguide part (11, 12) has a waveguide body (111, 121) and a part (110, 120) of at least one waveguide channel (10) which are arranged such that they form the at least one waveguide channel (10) when the two waveguide parts (11, 12) are joined together. The opposing surfaces (112, 122) of the two waveguide parts are parallel. A recess (2, 23-26) is provided in a side wall (114, 124) of a waveguide channel (10). The width (b) and the height (h) of the recess (2, 23-26) are substantially smaller than half the wavelength of a signal for which the at least one waveguide channel (10) is designed.

### FIELD

The present invention relates to a waveguide including two waveguide parts that are joined together. Each waveguide part has a part of at least one waveguide channel (i.e., a part of a waveguide channel or a part of a plurality of waveguide channels), in particular an upper or lower half of the at least one waveguide channel. The waveguide parts are, for example, welded, glued, screwed or similar. After the waveguide parts have been joined together, they form the at least one waveguide channel. Opposing surfaces of the two waveguide parts are parallel.

In addition, the present invention relates to a system comprising a waveguide and a further waveguide or a circuit board. The waveguide has a waveguide channel, which is connected at its output to the further waveguide or to the circuit board. The connection is made, for example, by welding, gluing or screwing. The surface of the waveguide at the output of the waveguide channel and the surface of the further waveguide, or the surface of the circuit board, that are being connected are parallel.

### BACKGROUND INFORMATION

Waveguides are, for example, produced by forming two waveguide parts and then joining them together. Each waveguide part has a waveguide body, into which a part of at least one waveguide channel is incorporated by means of conventional methods, such as milling or injection molding. The two waveguide parts are then joined together at their waveguide bodies, thus producing a firm connection. During assembly, the parts of the at least one waveguide channel are aligned one above the other and combined to form at least one waveguide channel. The parts are, for example, joined together by screwing, gluing, press-fitting, welding or similar.

Leakage of electromagnetic waves guided in the waveguide can occur at the joint. This is caused by the interruption of current paths on the surface due to imperfect galvanic contacts. The document by Montgomery et al., “Principles of Microwave Circuits.” Stevenage: IET, 1987, describes dividing the waveguide in a region in which only small or ideally no currents flow. In the case of a rectangular waveguide, this region for the fundamental mode is, for example, in the middle of the longer side. If the waveguide is divided in this region, the symmetry is largely preserved and no leakage occurs, even if there is an imperfect galvanic contact between the two waveguide parts, for example due to gluing or press-fitting.

However, even in this case, leakages cannot be completely avoided. Even if the design of the waveguide were perfectly symmetrical, which is usually not the case due to bends and components such as transistors, small defects and manufacturing tolerances result in a slightly asymmetrical waveguide, resulting in leakage of at least a small amount of energy between the waveguide parts. However, small asymmetries also lead to smaller leakages so that, if the asymmetry is small enough, depending on the application, the leakage is negligible.

Typically, a gap remains between the waveguide bodies. The mutually aligned surfaces of the waveguide bodies run in parallel with one another so that they can be regarded as plates of a plate capacitor. Even the smallest leakages can generate an excitation of a parallel-plate mode between the parallel surfaces of the waveguide bodies of the waveguide parts. As long as the amount of energy is small enough, the leakage can be neglected. However, the excitation can cause resonance within the gap between the two waveguide bodies of the waveguide parts or between adjacent waveguide channels. Through resonance, the amount of energy of the parallel-plate mode can be drastically increased, resulting in a reduction in the mode propagating in the waveguide. As a result, leakage is increased and the power of the waveguide (or of a waveguide antenna using the waveguide) is reduced. The occurrence of resonances depends on the frequency used and geometric boundary conditions of the waveguide and the gap between the waveguide parts. This may have the result that waveguide designs cannot be used or require welding during assembly.

Leakage of electromagnetic waves can also occur when connecting a waveguide to a further waveguide or a circuit board. In this case, the waveguide does not have to consist of two waveguide parts as described above. Typically, a gap remains between the waveguide bodies. The surface of the waveguide and the surface of the further waveguide or the surface of the circuit board run in parallel with one another at the connection point so that they can be regarded as plates of a plate capacitor. Even the smallest leakages can generate an excitation of a parallel-plate mode between the parallel surfaces. As long as the amount of energy is small enough, the leakage can be neglected. However, the excitation can cause resonance within the gap between the waveguide and the further waveguide or the circuit board. Through resonance, the amount of energy of the parallel-plate mode can be drastically increased, resulting in a reduction in the mode propagating in the waveguide. As a result, leakage is increased and the power of the waveguide (or of a waveguide antenna using the waveguide) is reduced. The occurrence of resonances depends on the frequency used and geometric boundary conditions of the waveguide and the gap between the waveguide and the further waveguide or the circuit board. This may have the result that waveguide designs cannot be used or require welding during assembly.

### SUMMARY

According to an example embodiment of the present invention, the waveguide has a recess provided in a side wall of a waveguide channel. The recess is preferably provided perpendicularly to the side wall in said side wall and forms a cavity in the side wall. The recess can have different shapes, for example rectangular, round, conical or similar. The width and height of the recess at the side wall are substantially smaller than half the wavelength of a signal in free space (<<λ₀/2) for which the at least one waveguide channel is designed. The wavelength of the signal in free space corresponds to the wavelength of the parallel-plate mode. For example, the width and height of the recess are each approximately a quarter of the wavelength of the signal in free space (<λ₀/4). The position and depth of the recess can basically be chosen freely, as long as the condition is met that the width and height are substantially smaller than half the wavelength of the signal in free space. Due to the dimensions of the recess, the recess neither influences the propagation mode in the waveguide channel nor interacts therewith so that the power of the propagation mode is not changed since the cutoff frequency for the recess is not reached.

According to one aspect of the present invention, the recess is provided in a waveguide consisting of two joined waveguide parts and is positioned there at the joint. The parallel-plate mode forms in the gap between the two waveguide bodies of the waveguide parts, which is produced by imperfect joining.

According to a further aspect of the present invention, a recess is provided in a system comprising a waveguide and a further waveguide or a circuit board, which further waveguide or circuit board is connected to the waveguide. The waveguide of the system can generally be any type of waveguide, i.e., either the waveguide described above, which consists of two waveguide parts, or a one-piece waveguide, and has at least one waveguide channel. The further waveguide or the circuit board is connected to the outer side of the waveguide at which the output of the waveguide channel is located. The output of the waveguide channel is the opening through which the signal is coupled out of or into the waveguide; an input of the waveguide channel is therefore also regarded as an output here. Explicitly, the opening of a part of the waveguide channel, which is closed during assembly to form the waveguide channel, is thus not to be regarded as an output. The parallel-plate mode forms at a gap in the connection between the waveguide body of the waveguide and the waveguide body of the further waveguide or a coupling point of the circuit board.

The recess can be regarded as a stub. As a result, the propagation properties of the parallel-plate mode at the surface of the waveguide body are changed, whereby the resonance frequency is shifted or the resonance is attenuated. Through the positioning and the number of recesses, the resonance frequencies of the waveguide bodies can be controlled and removed from the relevant frequency band. As a result, the leakage of energy from the waveguide is reduced.

According to an example embodiment of the present invention, preferably, the recess is provided in the surface of the waveguide body via which the joining or connection is made and at which the parallel-plate mode is generated. When joining the waveguide parts, the relevant surface of the waveguide body is the one that faces the other waveguide part and into which the part of the at least one waveguide channel is incorporated. When connecting to a further waveguide or a circuit board, the relevant surface is the one that has the output of the waveguide channel. There, the propagation properties of the parallel-plate mode can be effectively changed. In addition, the surface is easily accessible from the outside for processing.

According to an example embodiment of the present invention, in the case of the waveguide including two waveguide parts, a recess is preferably provided in the relevant surface in each of the two waveguide parts. The positions and shapes of the recesses correspond to one another. When the waveguide parts are joined together, the recesses of the two waveguide parts fit together in such a way that they form a common recess in the at least one waveguide channel. This makes it easy to provide the recess during the manufacture of the waveguide parts. In addition, the recess in this case is arranged symmetrically in the waveguide channel.

It is also possible for a plurality of recesses to be provided in the side wall, which are arranged next to one another and preferably at the same height. This allows the parallel-plate modes to be suppressed selectively and particularly effectively.

The recess has a particularly advantageous effect in the waveguide channel designs described below, but can be applied to any design.

In one embodiment of the present invention, the waveguide consisting of two waveguide parts has a bent or kinked waveguide channel, which surrounds a region, in which a resonant cavity can form in the gap between the two waveguide parts. Resonance forms when one dimension of the resonant cavity corresponds approximately to half the free-space wavelength (or a multiple thereof) of the signal propagating through the waveguide channel (1≈λ₀/2). The recess is preferably arranged in this region of the waveguide body of the first waveguide part that is surrounded by the bent or kinked waveguide channel. This destroys the resonant cavity and significantly reduces the parallel-plate mode in the gap between the waveguide bodies. In general, any shape of waveguide that surrounds such a region in which a resonant cavity can form can be relevant. The following shapes are particularly relevant: a U-shaped waveguide channel, in which the waveguide channel runs in parallel at the two legs, a V-shaped waveguide channel or an L-shaped waveguide channel, in which the legs are at an angle to one another.

In a further embodiment of the present invention, the waveguide consisting of two waveguide parts has two parallel waveguide channels. In the region of the waveguide body between the two parallel waveguide channels, a resonant cavity can form in the gap between the two waveguide parts. In addition, unwanted energy coupling can occur between the two waveguide channels. Resonance forms when the distance between the two parallel waveguide channels corresponds approximately to half the free-space wavelength (or a multiple thereof) of the signal propagating through the waveguide channel (1≈λ₀/2). For this embodiment, a plurality of recesses arranged next to one another is particularly advantageous. This destroys the resonant cavity and significantly reduces the parallel-plate mode in the gap between the waveguide bodies. This also prevents energy coupling between the waveguide channels across the gap.

According to an example embodiment of the present invention, the recess is also particularly advantageous if the waveguide has a choke at the connection to the further waveguide or the circuit board. The choke is used to reduce leakage, in particular if the connection is not made by welding. However, such a choke only works optimally with perfect symmetry. Any misalignment of the waveguide to the further waveguide or to the coupling point of the circuit board destroys the symmetry and causes resonances on the surface of the waveguide body between the waveguide channel and the choke. The cutout is preferably provided in the side wall of the waveguide channel that is located in the direction of the choke. Preferably, the cutout penetrates through the side wall and connects the choke to the waveguide channel. This destroys the resonance between the waveguide channel and the choke.

### BRIEF DESCRIPTION OF THE DRAWINGS

Exemplary embodiments of the present invention are illustrated in the figures and explained in more detail in the following description.

FIG. 1 shows a sectional view of a waveguide, which is assembled from two waveguide parts, with a waveguide channel.

FIG. 2 shows a sectional view of a depression in the waveguide according to an example embodiment of the present invention.

FIG. 3 shows an isometric view of the top side of a waveguide part of an exemplary embodiment of the waveguide according to the present invention with a first design of a waveguide channel.

FIG. 4 shows an isometric view of the top side of a waveguide part of an exemplary embodiment of the waveguide according to the present invention with a second design of a waveguide channel.

FIG. 5 shows an isometric view of a front side of a further exemplary embodiment of the waveguide according to the present invention with a choke at the output of the waveguide channel.

### DETAILED DESCRIPTION OF EXAMPLE EMBODIMENTS

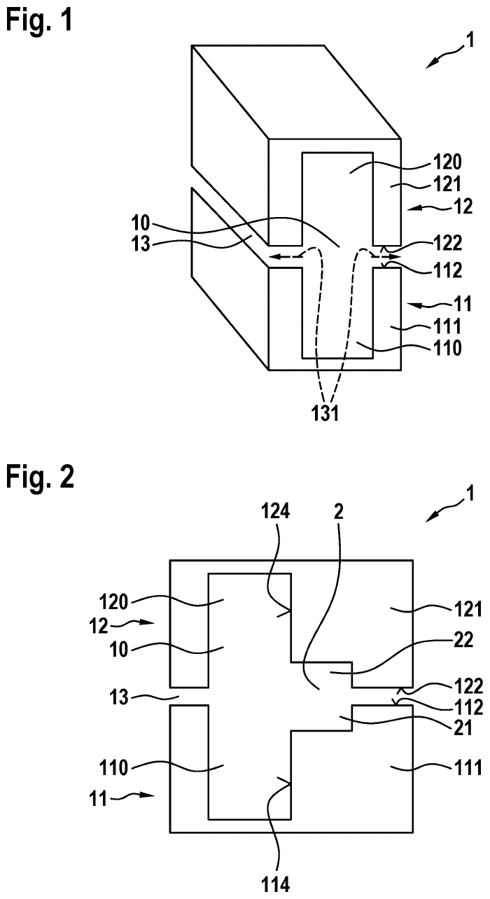

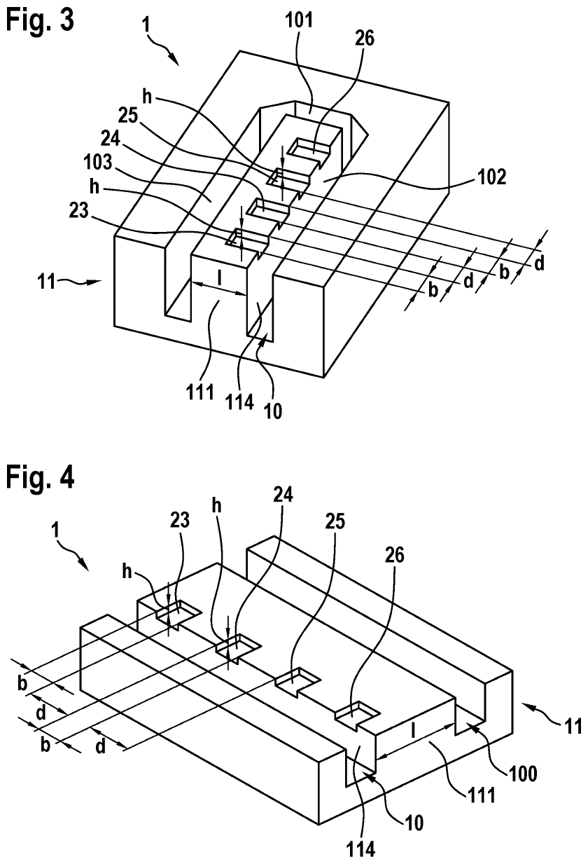

FIG. 1 shows a waveguide 1, which includes two waveguide parts 11, 12. The first waveguide part 11 has a waveguide body 111, in which a cutout 110 is provided, which in this example has a rectangular cross-section and extends in the third direction through the waveguide body 111. Likewise, the second waveguide part 12 has a waveguide body 121, in which a cutout 120 is provided, which in this example has the same shape as the aforementioned cutout 110 of the first waveguide part 11. Outside the cutouts, the waveguide bodies 111, 121 have opposing surfaces 112 and 122 that run in parallel with one another. For assembling the waveguide 1, the two waveguide parts 11, 12 are joined together at these surfaces 112 and 122. In addition to welding, gluing or screwing can be used as joining methods. By joining, the two cutouts 110 and 120 together form a waveguide channel 10 designed as a rectangular hollow conductor, in which electromagnetic signals (not shown here) can be guided. That is to say, the cutouts 110, 120 are parts of the waveguide channel 10 which can easily be formed, for example by milling or injection molding, in the waveguide bodies 111, 121 in the separated state and form the waveguide channel 10 in the assembled state. By means of appropriately designed cutouts 110, 120, different shapes of waveguide channels and also a plurality of waveguide channels can be provided in the same waveguide 1. Reference is made in this respect to FIGS. 3 and 4. During assembly, a gap 13, which is shown disproportionately large in the present figures, may be produced between the surfaces 112 and 122. Since the two surfaces 112 and 122 are parallel to one another, a parallel-plate mode may form in the gap 13. This leads to leakage, represented by the arrows 131, of electromagnetic energy of the signals guided in the waveguide channel 10, as a result of which the energy of the signal in the waveguide channel 10 decreases.

In the further figures, identical components are identified by identical reference signs and reference is made to the above description for an explanation thereof.

FIG. 2 shows a detail of the waveguide 1 according to the present invention, which is constructed as shown in FIG. 1. The waveguide 1 according to the present invention has a recess 2, which extends perpendicularly from the waveguide channel 10 into the waveguide bodies 111, 121 and is formed symmetrically to the gap 13. The first waveguide part 11 has a rectangular recess 21 on its surface 112 in a side wall 114 of the waveguide channel 10, i.e., of the cutout 110 which represents the part of the waveguide channel 10. The second waveguide part 12 has a rectangular recess 22 on its surface 122 in a side wall 124 of the waveguide channel 10, i.e., of the cutout 120 which represents the other part of the waveguide channel 10, which rectangular recess corresponds to the recess 21 in the first waveguide part 12 and is arranged at the same position. By joining the waveguide parts 11, 12 together, the two recesses 21 and 22 together form the common recess 2, which here has a cuboid shape. In other embodiments not shown here, the recess 2 can also take on other shapes, for example a cylindrical shape. The recess 2 has a height h that is substantially smaller than the wavelength of the signal in free space (h<<λ₀) and here, for example, is a quarter of the wavelength of the signal in free space (h=λ₀/4). The recess also has a width d (which is not shown in FIG. 2 since it extends into the drawing plane; see FIGS. 3 and 4) that is also substantially smaller than the wavelength of the signal in free space (d<<λ₀) and here, for example, is also a quarter of the wavelength of the signal in free space (b=λ₀/4).

FIGS. 3 and 4 each show exemplary embodiments of the waveguide 1 according to the present invention with different designs of the waveguide channel 10. FIGS. 3 and 4 each show an isometric plan view of the first waveguide part 11. The second waveguide part 12 is not shown for reasons of clarity, but is designed the same as the first waveguide part 11.

In FIG. 3, the waveguide channel 10 is U-shaped and has a base portion 101 and two parallel leg portions 102, 103. The base portion 101 and the leg portions 102 and 103 surround a region of the waveguide body 111 on three sides. If the length l of this region of the waveguide body 111 between the leg portions 102, 103, i.e., the distance between the leg portions 102, 103, is close to half the wavelength of the signal in free space (l≈λ₀/2), a resonant cavity can form in the gap 13 between the parallel waveguide bodies 111 and 121 in the surrounded region, which cavity increases the leakage of electromagnetic energy. In other exemplary embodiments not shown, the waveguide channel can be V-shaped or L-shaped and can also surround a region in which a resonant cavity can form. According to the present invention, a plurality of recesses (here four) 23 to 26 is provided in the side wall 114 of the one leg portion 102 of the waveguide channel 10 in the direction of the surrounded region. As shown with reference to FIG. 2, these recesses 23 to 25 together with the recesses of the second waveguide part 12 (not shown) form common recesses. The recesses 23 to 26 each have the same width b and the same height h, which are each substantially smaller than half the wavelength of the signal in free space and here, for example, are a quarter of the wavelength of the signal, and they are each arranged at the same distance d, which here, for example, corresponds approximately to half the wavelength of the signal (d≈λ₀/2). The recesses 23 to 26 change the geometric boundary conditions so that the parallel-plate mode is suppressed and no or only minimal leakage occurs.

FIG. 4 shows two waveguide channels 10 and 100, which run in parallel with one another. The waveguide channels enclose a region of the waveguide body 111 from two opposite sides. If the length 1 of this region of the waveguide body 111 between the waveguide channels 10, 100, i.e., the distance between the waveguide channels 10, 100, is close to half the wavelength of the signal in one of the waveguide channels 10, 100 (l≈λ₀/2), a resonant cavity can form in the gap 13 between the parallel waveguide bodies 111 and 121 in the surrounded region, which cavity increases the leakage of electromagnetic energy. According to the present invention, a plurality of recesses (here four) 23 to 26 is provided in the side wall 114 of the one leg portion 102 of the waveguide channel 10 in the direction of the other waveguide channel 100 and of the surrounded region. As shown with reference to FIG. 2, these recesses 23 to 26 together with the recesses of the second waveguide part 12 (not shown) form common recesses. The recesses 23 to 26 each have the same width b and the same height h, which are each substantially smaller than half the wavelength of the signal in free space and here, for example, are a quarter of the wavelength of the signal, and they are each arranged at the same distance d, which here, for example, corresponds approximately to half the wavelength of the signal (d≈λ₀/2). The recesses 23 to 26 change the geometric boundary conditions so that the parallel-plate mode is suppressed and no or only minimal leakage occurs.

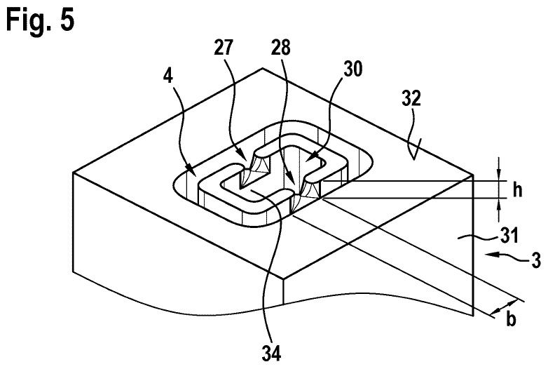

FIG. 5 shows a view of the front side of a waveguide 3. The waveguide 3 can be the waveguide 1 described above and consisting of two waveguide parts. In general, the waveguide 3 can also be designed in another way, e.g., in one piece. The waveguide 3 has a waveguide body 31 and, therein, a waveguide channel 30 designed as a rectangular hollow conductor. The output of the waveguide channel 30 is located on the front-facing surface 32 of the waveguide body 31. The waveguide 3 is connected via this surface 32 to a further waveguide (not shown here) or to a circuit board (also not shown) so that signals are coupled into or out of the further waveguide or a coupling point of the circuit board via the output of the waveguide channel 30. At the output of the waveguide channel 30, a choke 4 is provided, which surrounds the waveguide channel 30. According to the present invention, two recesses 27 and 28 are provided in the side wall 34 of the waveguide channel 30 on the surface 32, which recesses are opposite one another and arranged in parallel with one another. In this example, the recesses 27, 28 are each provided on the long sides of the rectangular waveguide channel 30. In other exemplary embodiments not shown, a different number and arrangement of the recesses is provided; for example, two recesses can be provided on each of the long sides and two recesses on each of the short sides. The recesses 27, 28 penetrate through the side wall 34 and thus connect the waveguide channel 30 and the choke 4. As a result, a resonance that would form between the waveguide channel 30 and the choke 4 in the gap between the surface 32 of the waveguide body 32 of the waveguide 3 and of the further waveguide or the circuit board is interrupted, and no or only minimal leakage occurs.

1-12. (canceled)

13. A waveguide, comprising:
two waveguide parts, each of the two waveguide parts having a respective waveguide body and a respective part of at least one waveguide channel, the respective parts of the at last one waveguide channel being arranged to form the at least one waveguide channel when the two waveguide parts are joined together, the opposing surfaces of the two waveguide parts being parallel;
wherein a recess is provided in a side wall of the waveguide channel, a width and the height of the recess being substantially smaller than half the wavelength of a signal for which the at least one waveguide channel is configured.

14. The waveguide according to claim 13, wherein the recess is provided perpendicularly to the side wall in the side wall.

15. The waveguide according to claim 13, wherein the recess is provided in the surface of the waveguide body.

16. The waveguide according to claim 15, wherein, in each of the two waveguide parts, a recess is provided in a respective surface, and positions of the recesses is the respective surfaces correspond so that, in an assembled state of the waveguide, the respective recesses fit together such that they form a common recess.

17. The waveguide according to ckaun 13, whherein each of the two waveguide parts has a plurality of recesses, which are arranged next to one another.

18. The waveguide according to claim 13, wherein the waveguide has a bent or kinked waveguide channel, which surrounds a region, the recess is provided in the region of the waveguide body that is surrounded by the bent or kinked waveguide channel.

19. The waveguide according to claim 13, wherein the waveguide has two parallel waveguide channels, the recess is provided in a side wall of one of the waveguide channels in a direction of the other one of the waveguide channels.

20. A system, comprising:
a waveguide, which has at least one waveguide channel, and: (i) a further waveguide or (ii) a circuit board, the at least one waveguide channel being connected at its output to the further waveguide or to the circuit board, wherein a recess is provided in a side wall of the at least one waveguide channel, a width and a height of the recess being smaller than half the wavelength of a signal for which the at least one waveguide channel is configured.

21. The system according to claim 20, wherein the recess is provided perpendicularly to the side wall in the side wall.

22. The system according to claim 20, wherein the recess is provided in a surface of a waveguide body of the waveguide.

23. The system according to claim 20, wherein the waveguide has a plurality of recesses.

24. The system according to claim 20, wherein the waveguide has a choke, and the recess in the side wall of the waveguide channel is provided toward the choke.
